(19) United States
(12) Patent Application Publication
(10) Pub. No.: US 2012/0198786 A1
(43) Pub. Date: Aug. 9, 2012

(54) DOOR CORNER ASSEMBLY

(75) Inventor: Joe David Williams, Tuscaloosa, AL (US)

(73) Assignee: Vitro America, LLC, Memphis, TN (US)

(21) Appl. No.: 13/023,451

(22) Filed: Feb. 8, 2011

(51) Int. Cl. E06B 3/968; E06B 1/52

(52) U.S. Cl. 52/656.4

(57) ABSTRACT

A door corner assembly having a tubular vertical stile having a first face defining a first aperture; a tubular corner block having a bottom surface, two side surfaces and a beveled nose defining at least one nose aperture along a longitudinal center line of the nose, wherein the nose aperture is in alignment with a second aperture defined by the bottom surface; the corner block further defining first and second screw splines; wherein the corner block is secured to the stile with a first fastener extending through the first and second apertures; and a tubular rail member, wherein the tubular rail member receives the corner block inside an open end of the tubular rail member and wherein the corner block is secured within the tubular rail member by a second fastener extending through an opening in the rail member and engaged with one of the first and second screw splines.

### BACKGROUND OF THE INVENTION

1. Field Of The Invention

The present invention relates generally to the field of extruded metal door assemblies and more particularly to corner joinery for such assemblies.

2. Description Of The Related Art

Typical aluminum door corner assemblies require multiple fasteners between the stiles and rail assemblies, generally disposed near the outside edges of such components. In addition, such typical aluminum door corner assemblies do not withstand high wind pressures, especially when incorporating known 3-point lock designs.

Thus, it would be desirable to have an efficient door corner assembly requiring a reduced number of fasteners also capable of withstanding high wind pressures.

### BRIEF SUMMARY OF THE INVENTION

Accordingly, there is a need for a door corner assembly comprising a tubular corner block that only requires a total of two (2) fasteners to attach each corner block to the top/bottom rails of the door corner assembly. This accomplished by the unique tubular corner block design which has two screw splines located in the center rather than two splines located on the sides of a channel shaped corner block typically used in most existing corner assemblies. In order to locate the screw splines in the center, it was desirable to design the door top/bottom rail and vertical stiles with a special dimension to allow FHP tapping screws to be inserted in the center and yet not interfere with glass stops (used to hold the glass in place on the door.

In a first aspect, the present invention comprises a door corner assembly having a tubular vertical stile having a first face defining a first aperture; a tubular corner block having a bottom surface, two side surfaces and a beveled nose defining at least one nose aperture along a longitudinal center line of the nose, wherein the nose aperture is in alignment with a second aperture defined by the bottom surface; the corner block further defining first and second screw splines; wherein the corner block is secured to the stile with a first fastener extending through the first and second apertures; and a tubular rail member, wherein the tubular rail member receives the corner block inside an open end of the tubular rail member and wherein the corner block is secured within the tubular rail member by a second fastener extending through an opening in the rail member and engaged with one of the first and second screw splines.

In another aspect of the present invention, the door corner assembly has a corner block that is secured within the tubular rail member by two second fasteners wherein each second fastener extends through one of first and second openings in the tubular rail member and engages with one of the first and second screw splines.

In yet a further aspect of the present invention, the door corner assembly has corner block also comprising a pair of elongated dovetail members disposed on the outside of the bottom surface of the corner block, wherein the dovetail members are slidingly received by a pair of elongated glass stops on the first face of the stile.

In yet another aspect of the present invention, a face of each elongated glass stop defines an angle with the first face and/or a face of each dovetail member opposes the face of one of the elongated glass stops when the corner block is secured to the stile.

In yet an additional aspect of the present invention, the door corner assembly further comprises a combination washer/guide member disposed within the tubular stile, wherein the combination washer/guide member comprises a washer portion defining a washer opening through which the first fastener extends and a guide portion defining a guide opening.

### BRIEF DESCRIPTION OF THE DRAWINGS

The above and other objects and advantages of the present invention will become apparent from the following description when read in conjunction with the accompanying drawings wherein:

FIG. 1 illustrates an exploded perspective view of a preferred embodiment of a door corner assembly of the present invention.

FIG. 2 is a side perspective view of a preferred corner block of the door corner assembly of the present invention.

FIG. 3 is a cross-sectional view of a preferred vertical stile of a door corner assembly of the present invention.

FIG. 4 is a side plan view of the corner block of FIG. 2.

FIG. 5 shows top plan views of preferred corner blocks of various sizes for door corner assemblies of the present invention.

FIG. 6 is a cross-sectional view of a preferred top/bottom rail of a door corner assembly of the present invention.

FIG. 7 is a cross-sectional view of another preferred top/bottom rail of a door corner assembly of the present invention.

FIG. 8 is a bottom plan view of a preferred top/bottom rail of a door corner assembly of the present invention

FIG. 9 is another bottom plan view of a preferred top/bottom rail of a door corner assembly of the present invention.

FIG. 10 is a top plan view of a preferred top/bottom rail of a door assembly of the present invention.

FIG. 11 is a top plan view of a preferred corner block attached to a preferred vertical stile of a preferred door corner assembly of the present invention.

FIG. 12 shows various sizes of a preferred combination back-up plate and guide of a door corner assembly of the present invention.

FIG. 13 is an exploded, perspective view of a preferred door corner assembly of a vertical stile and a top/bottom rail according to the present invention.

FIG. 14 is a top perspective view of a bottom rail attached to a vertical stile in a door corner assembly of the present invention.

### DETAILED DESCRIPTION OF THE PREFERRED EMBODIMENTS

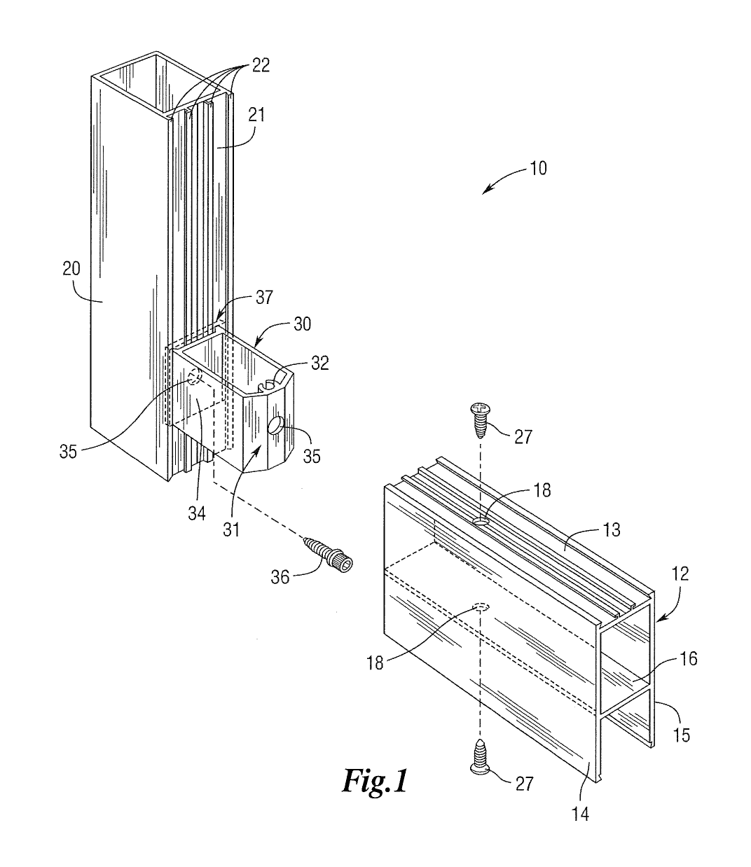

FIG. 1 shows an exploded view of a preferred door corner assembly 10 of the present invention comprising a top/bottom rail 12, a vertical stile 20 and a corner block 30. FIG. 1 shows the preferred door corner assembly 10 according to the present invention for only one of four corners of s door. The assemblies of the other three door corners are identical in all material respects except differing orientations of the various components as required.

As shown in FIGS. 1 and 6-7, top/bottom rail 12 comprises a tubular construction having a face 13, side walls 14 and 15 and a transverse support plate 16. Elongated glass stops 17, for securing the door glass panels (not shown), are disposed on or integrally formed with face 13. Holes 18 which may or may not be threaded are disposed in face 13 and in transverse support plate 16 in alignment with each other as shown in FIG. 1.

Vertical stile 20 also comprises a tubular construction having a face 21 with glass stops 22 disposed thereon or formed integrally therewith. Face 21 also has at least one hole 35, which may be threaded or not, for attaching corner block 30 to stile 20. As shown in FIG. 4, stile 20 preferably has a cross section that is hollow and generally square or rectangular, but preferably not precisely square or rectangular as shown.

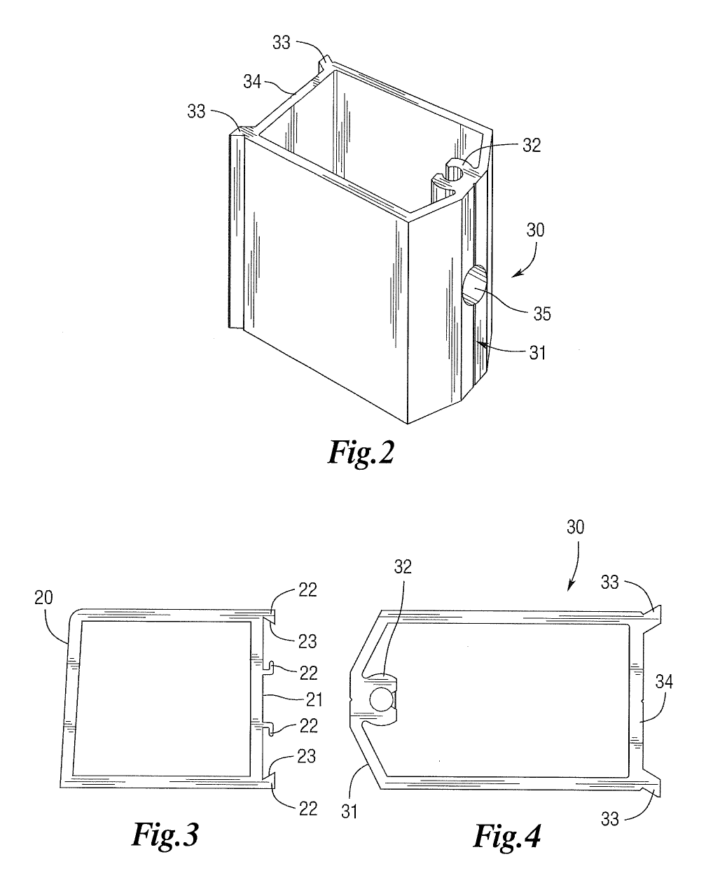

Corner block 30 is also of a tubular construction and preferably comprises an aluminum extrusion. Corner block 30 has a top nose portion 31 which is crowned or beveled as shown in FIGS. 1-3. On the interior of the top nose portion 31, threaded screw splines or bosses 32 are disposed near the sides of the top nose portion 31 for receiving FHP tapping screws 27 or the equivalent for securing the corner block 30 within a top/bottom rail 12 as shown in FIG. 1. Corner block 30 also preferably comprises angled feet or dove tails 33 which are slidably received with outer, elongated glass stops 22 having a complimentary inside bevel 23 for receiving dovetails 33. This dovetailed connection of the corner block 30 to stile 20 provides extra strength and stability to the door corner assembly 10. Both the top nose portion 31 and base 34 of corner block 30 define holes 35, which may or may not be threaded, for attaching corner block 30 to stile 20 using a cap socket head screw 36 or equivalent fastener. As shown in FIG. 1, hole 35 in top nose portion 31 allows a tool to be inserted into nose 30 for tightening screw 36 through base 34 and square nut 37 disposed within the tubular stile 20.

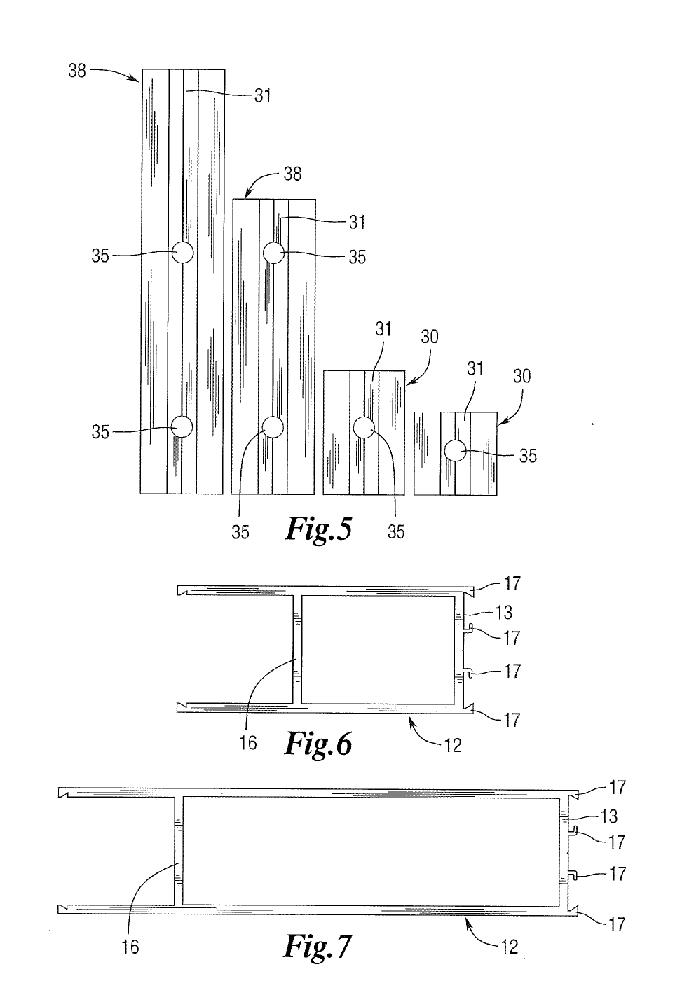

FIG. 5 shows corner block 30 of various sizes for use with preferred embodiments of the door corner assembly 10 of the present invention. The longer corner blocks 38 shown in FIG. 5 require additional holes 35 to enable extra screws or fasteners 36 to be used in securing such corner blocks 38 to stiles 20.

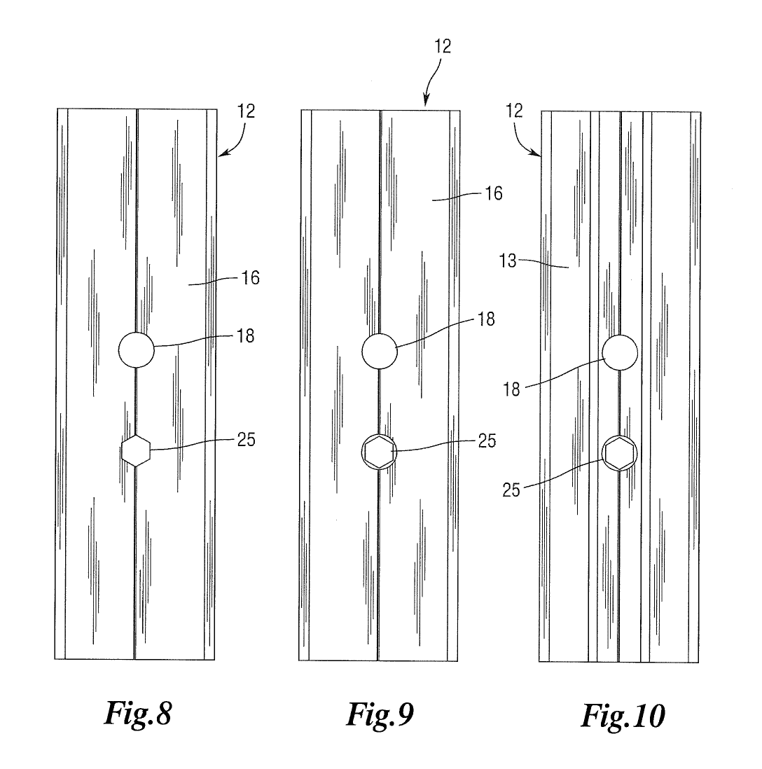

FIGS. 8-10 illustrate a preferred method of forming holes 18 in the top/bottom rails 12 and holes 35 in corner blocks 30 and 38, as well as in the vertical stiles 20. As shown in FIG. 8, to produce round hole 18, a hexagonal precursor hole 25 preferably is punched into the surface in which the hole is to be formed. The punching of the hexagonal hole 25 displaces enough material to enable the next punch operation to create a countersink without forcing material through to the exit side of the extrusion as would be the case if a standard punch and dimple fabrication method were used. Because the corner block 30 preferably slide fits tightly into the tubular inside dimensions of the top/bottom rails 12, this preferred method of punching holes 18 eliminates any need for removing material from the inside of the tube of top/bottom rail 12 that would exist if a standard punch and dimple process. FIG. 9 shows hole 25 in the underside of transverse plate 16 while FIG. 10 shows hole 25 in face 13 after at least one more punching step.

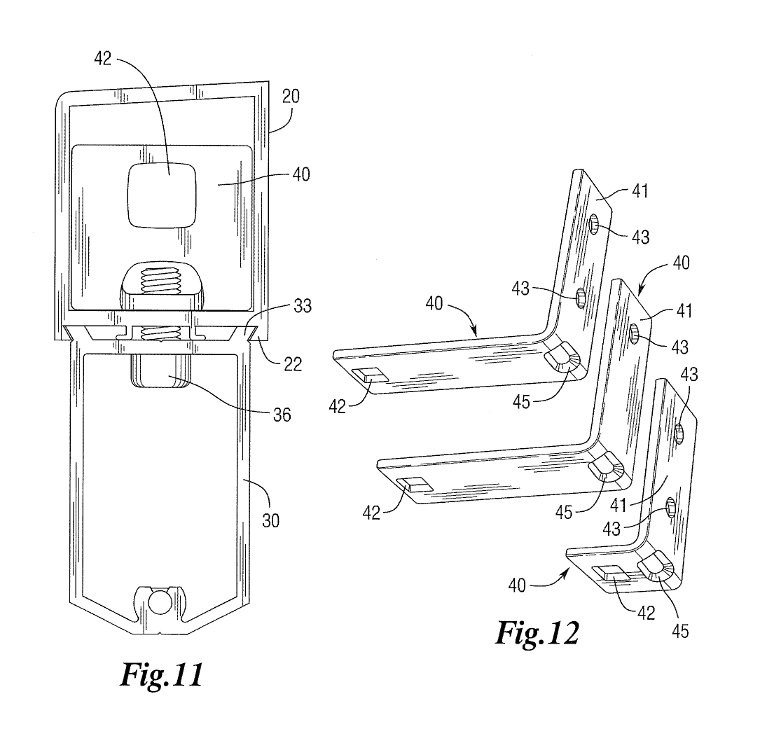

FIG. 11 shows corner block 30 assembled to stile 20 using screw 36 and a combination back-up plate (washer) and guide 40 for use in active stiles 20 of all doors using a 3-point locking mechanism. The opening 42 of guide 40 receives and guides the rod (not shown) of such 3-point locks. As shown in FIG. 12, guides 40 may be fabricated in various sizes to accommodate door assemblies 10 of different sizes. Each guide 40 comprises a washer section 41 having threaded holes 43 for receiving one or more screws 36 used to attach corner block 30 to stile 20. Guides 40 also preferably define oval shaped openings 45 to allow guide 40 to be bent at 90 degrees to position guide opening 42 to receive the rod of a 3-point lock.

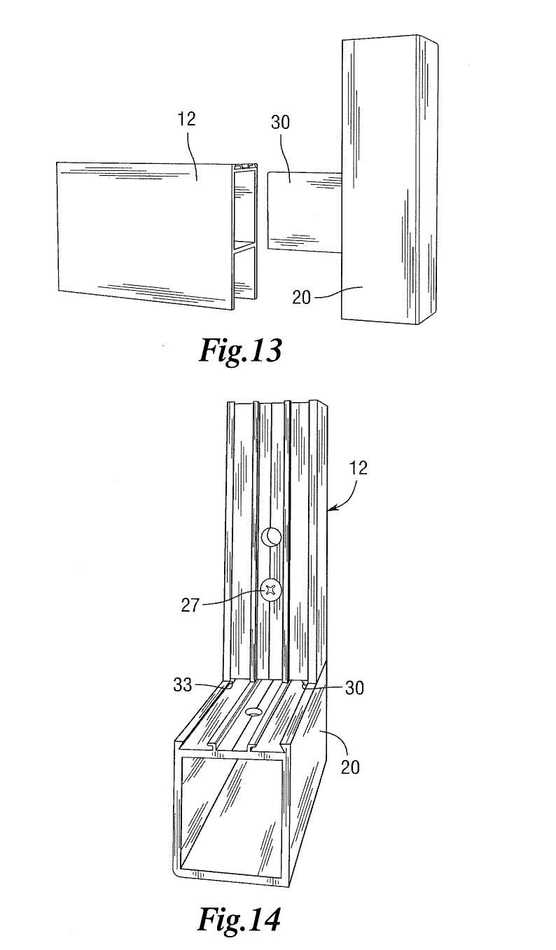

FIGS. 13-14 show an exploded view of a door corner assembly 10 of the present invention and the completed door corner assembly 10, respectively. As shown therein, corner block 30, attached to stile 20, is ready for insertion into and attachment with the top/bottom rail 12. As shown in FIG. 14, the corner block 30 is attached to top/bottom rail 12 using screws 27.

The foregoing is to be construed as only being an illustrative embodiment of this invention. Persons skilled in the art can easily conceive of alternative arrangements providing functionality similar to this embodiment without any deviation from the fundamental principles or the scope of this invention.

As various changes could be made in the above constructions, products, and methods without departing from the scope of the invention, it is intended that all matter contained in the above description and shown in the accompanying drawings shall be interpreted as illustrative and not in a limiting sense. The invention, therefore, is not to be restricted except in the spirit of the appended claims.

What is claimed is:

1. A door corner assembly comprising:
a tubular vertical stile having a first face defining a first aperture;
a tubular corner block having a bottom surface, two side surfaces and a beveled nose defining at least one nose aperture along a longitudinal center line of said nose, wherein said nose aperture is in alignment with a second aperture defined by said bottom surface;
said corner block further defining first and second screw splines;
wherein said corner block is secured to said stile with a first fastener extending through said first and second apertures; and
a tubular rail member, wherein said tubular rail member receives said corner block inside an open end of said tubular rail member and wherein said corner block is secured within said tubular rail member by a second fastener extending through an opening in said rail member and engaged with one of said first and second screw splines.

2. The door corner assembly of claim 1 wherein said corner block is secured within said tubular rail member by two second fasteners wherein each second fastener extends through one of first and second openings in said tubular rail member and engages with one of said first and second screw splines.

3. The door corner assembly of claim 1 wherein said corner block also comprises a pair of elongated dovetail members disposed on the outside of said bottom surface, wherein said dovetail members are slidingly received by a pair of elongated glass stops on said first face of said stile.

4. The door corner assembly of claim 3 wherein a face of each elongated glass stop defines an angle with said first face.

5. The door corner assembly of claim 3 wherein a face of each dovetail member opposes the face of one of said elongated glass stops when said corner block is secured to said stile.

6. The door corner assembly of claim 1 further comprising a combination washer/guide member disposed within said tubular stile, wherein said combination washer/guide member comprises a washer portion defining a washer opening through which said first fastener extends and a guide portion defining a guide opening.
